(19) United States
(12) Patent Application Publication
(10) Pub. No.: US 2006/0027095 A1
(43) Pub. Date: Feb. 9, 2006

(54) Piston having centered pin hole and skirt profile

(76) Inventor: Andrew John Miller, Plymouth, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/194,429

(22) Filed: Aug. 1, 2005

Related U.S. Application Data
(60) Provisional application No. 60/598,009, filed on Aug. 2, 2004.

(51) Int. Cl. F16J 1/04

(52) U.S. Cl. 92/208

(57) ABSTRACT

A piston includes a piston body having a longitudinal central axis. A piston head is formed with a plurality of ring grooves and a pair of pin bosses depend from the head and are formed with a pair of pin bores that are centered on a common pin bore axis that intersects the longitudinal axis of the piston. Skirt Portions have outer surfaces with a longitudinal profile that is convexly shaped. A major diameter of the profile lies within ±2 mm of the pin bore axis in both a cold and hot condition.

This invention claims priority to U.S. Provisional Application No. 60/598,009, filed Aug. 2, 2004.

### 1. TECHNICAL FIELD

This invention relates to pistons for internal combustion engines.

### 2. RELATED ART

Pin offset was traditionally added to pistons, in the days of the tapered skirt, to insure that the soft lower skirt would touch the cylinder bore prior to the rigged upper skirt. It has further been proposed to locate the major diameter of the skirt on the pin centerline, but in combination with the offset pin. Pin offset produces undesirable secondary motion of the piston in operation, leading to premature piston, ring and liner wear.

### SUMMARY OF THE INVENTION

A central pin and central skirt combination is employed to produce a symmetric piston design. With this design, inertia and gas loading no longer act on the piston to produce piston secondary motion.

The combination of the central pin and central skirt: 1) produces a quiet piston, 2) reduces stress in the piston open end and as a result, mass can be reduced, 3) allows for a tighter fitting land which will reduce blowby, 4) provides for less skirt contact area and contact in a soft area of the skirt which will reduce friction, 5) makes the central pin easier to manufacture, 6) reduces PCS assemblies of the central pin by eliminating handed pistons, 7) makes the piston easier to design correctly the first time 8) significantly reduces motion change at top dead centering firing, and enables a reduction in land clearance which reduces ring side wear and ring microwelding.

### THE DRAWINGS

These and other features and advantages of the present invention will become more readily appreciated when considered in connection with the following detailed description and appended drawings, wherein:

FIG. 1 is an elevation view of a piston; and

FIG. 2 is a bottom view of the piston of FIG. 1.

### DETAILED DESCRIPTION

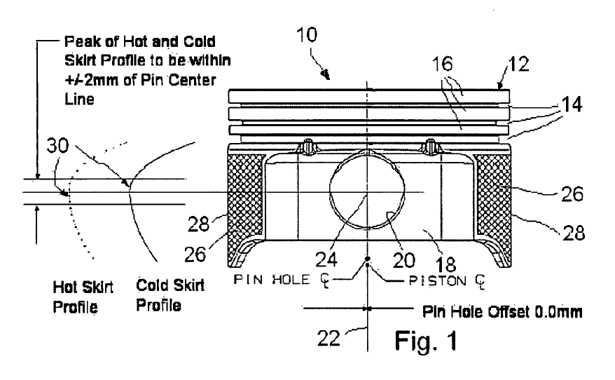

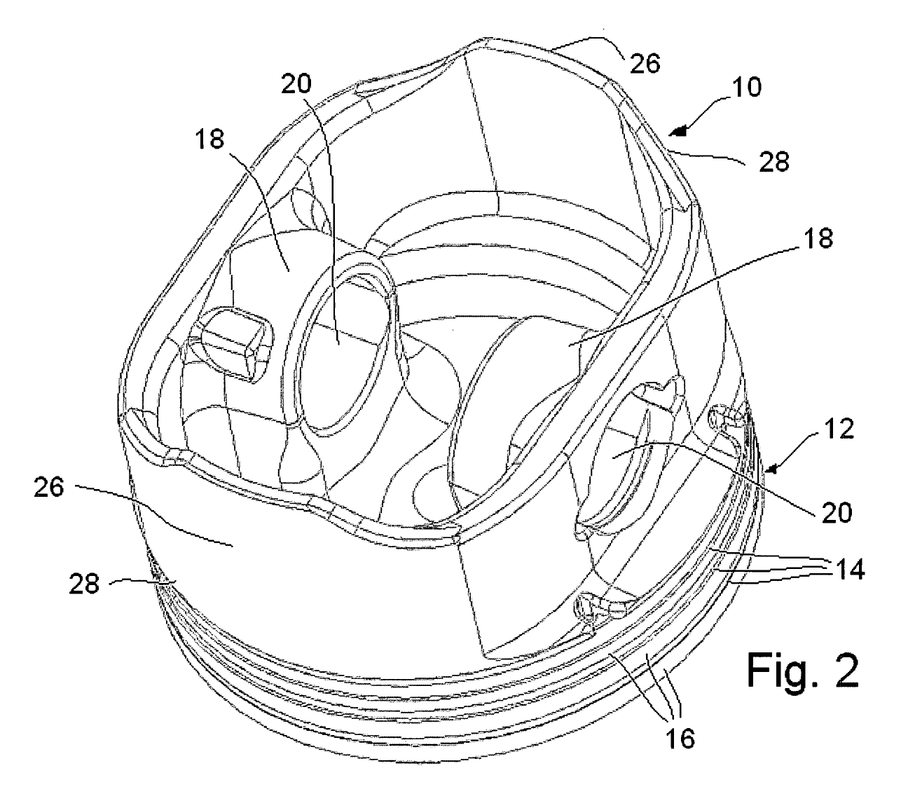

Referring to FIGS. 1 and 2, a piston 10 is shown having a head 12 formed with a plurality of ring grooves 14 for accommodating a plurality of piston rings (not shown). Between the ring grooves are lands 16. A pair of pin bosses 18 project below the head 12 and are spaced laterally from one another. The pin bosses 18 are formed with axially aligned pin bores or holes 20 for receiving a wrist pin (not shown) for attachment of the piston to a connecting rod (not shown) in conventional manner. The piston 10 has a longitudinal centerline or axis 22 which passes through the axis of the pin holes 20, such that there is no lateral offset of the pin hole axis 24 relative to the piston centerline 22.

The piston 10 includes skirt portions 26 on opposite sides of the piston 10 between the pin bosses 18. The skirt portions 26 each have an outer surface 28 with a skirt profile 30 that is convexly shaped in the longitudinal direction of the piston and skirt. The profile 30 has a major diameter (i.e., the furthest point radially outward from the centerline of the piston) that lies within ±2 mm of the pin hole centerline 22 when the piston is in both a cold condition (i.e., ambient temperature before operation) and a hot condition (i.e., heated to operating temperature). The combination of the centered pin hole and centered skirt profile provides advantages not apparent from the known prior pistons, including reduction in secondary motion and wear.

This skirt profile insures the soft central skirt is the only portion of the skirt that contacts the bore. The skirt profile is designed to have the skirt major diameter on the pin center line height. The difference in this design is that it is combined with central pin and that that the profile has aggressive drop on either side of the major diameter. This aggressive drop on either side of the major diameter insures that the major diameter is at the pin centerline at all piston temperatures, including cold start temperatures and hot running conditions.

Traditionally the piston lands were cut back to insure that the lands did not touch during operation, especially at startup. Piston land contact could cause noise, bore wear and scuffing. With the present profile, the pin offset and skirt offset no longer act on the piston to producing significant secondary motion. The only forces acting to produce secondary motion are skirt friction and pin friction. Accordingly, there is no need to cut back the piston lands and the piston land diameters on the subject central pin and central skirt profile piston are governed only by consideration of the thermal growth of the lands in operation. The land to bore clearance can be advantageously designed to be just enough to prevent seizure of the lands to the bore. If the lands do touch the bore, there is little energy in the lands to produce noise or scuffing since the piston is balanced and there is no secondary movement and resultant forces associated with the prior pistons having offset pin holes. As a result, the land can be advantageously used to help stabilize the piston.

Accordingly, the invention contemplates a piston having zero piston pin offset with respect to the longitudinal axis or centerline of the piston in combination with a convex piston skirt profile having its major diameter located within ±2 mm of the pin hole center line in the longitudinal direction of the piston in both the hot and cold conditions of the piston.

Obviously, many modifications and variations of the present invention are possible in light of the above teachings. It is, therefore, to be understood that within the scope of the appended claims, the invention may be practiced otherwise than as specifically described.

1. A piston comprising:
a piston body having a central longitudinal axis;
a piston head portion formed with a plurality of ring grooves;
a pin bore portion depending from said piston head portion formed with a pair of pin bores that are centered on a common pin bore axis that intersects said longitudinal axis of said piston body; and
a pair of skirt portions formed as one piece with said pin boss portions each having an outer surface with a skirt profile that is convexly shaped in the longitudinal direction and which has a major diameter that lies within ±2 mm of said pin bore axis when the piston is in both a cold condition before operation of the piston and a hot condition in which the piston has been heated to an operating temperature.

2. The piston of claim 1 wherein said outer surface of said skirt tapers to a smaller size in both longitudinal directions from said major diameter.

3. The piston of claim 1 wherein said taper is sufficient to preclude other regions of said skirt beyond said ±2 mm region from contacting a piston bore in which the piston operates when installed during operation of said piston.
